(19) United States
(12) Patent Application Publication
(10) Pub. No.: US 2001/0019925 A1
(43) Pub. Date: Sep. 6, 2001

(54) Contact socket

(76) Inventor: Hans Jost Heimueller, Dudenhofen (DE)

Correspondence Address: Tyco Technology Resources, Suite 450, 4550 New Linden Hill Road, Wilmington, DE, 19808, US

(21) Appl. No.: 09/774,331

(22) Filed: Jan. 31, 2001

(30) Foreign Application Priority Data
Jan. 31, 2000 (EP) 00101872.0

(51) Int. Cl. H01R 11/22; H01R 13/11

(52) U.S. Cl. 439/851

(57) ABSTRACT

A contact socket of a single-part construction, having a base spring and two spring legs, integrally formed on the base spring that have contacting sections facing each other where, as a result of the single-piece construction, the manufacturing process of this contact socket can be optimized and each spring leg is supported by an additional support member thereby increasing the resilient force.

### BACKGROUND OF THE INVENTION

The present invention relates to a contact socket.

### DESCRIPTION OF THE PRIOR ART

The known contact sockets have a complicated construction and are therefore difficult to manufacture. These known contact sockets are expensive to manufacture.

### SUMMARY OF THE INVENTION

It is therefore an object of the present invention to provide a contact socket allowing the design of a simpler manufacturing process and which thereby entails lower costs. This object is achieved by a contact socket having a base spring and two spring legs, integrally formed on the base spring that have contacting sections facing each other where, as a result of the single-piece construction, the manufacturing process of this contact socket can be optimized and each spring leg is supported by an additional support member thereby increasing the resilient force. Accordingly the contact socket, which is of a single-part construction, comprises a base spring and two internal spring legs, the contacting sections of which essentially face each other. The single-part construction allows the optimization of the manufacturing process which then essentially consists only of a bending operation and/or pressing operation.

A further advantage of the contact socket according to the invention is that the resilient force on each spring leg can be relatively easily increased by providing a support member which is also integrally formed on the base spring and on which the spring leg is then supported. The resilient force can hereby be significantly increased.

### BRIEF DESCRIPTION OF THE DRAWINGS

FIG. 1 shows a schematic cross-sectional view of a contact socket according to the invention, in accordance with a preferred embodiment of the present invention;

FIG. 2 shows a further cross-sectional view of a contact socket according to FIG. 1;

FIG. 3 shows a layout of the contact socket according to FIGS. 1 and 2;

FIG. 4 shows a diagram for explaining the bending operation of the contact socket according to the invention shown in FIGS. 1 to 3;

FIG. 5 shows a schematic cross-sectional view of a contact socket according to the invention, in accordance with a second embodiment of the present invention;

FIG. 6 shows a further cross-sectional view of a contact socket according to FIG. 2;

FIG. 7 shows a layout of the contact socket according to FIGS. 5 and 6;

FIG. 8 shows a schematic cross-sectional view of a contact socket according to the invention, in accordance with a third embodiment of the present invention;

FIG. 9 shows a further cross-sectional view of a contact socket according to FIG. 8;

FIG. 10 shows a partial cross-sectional view of the contact socket according to FIGS. 8 and 9, as seen from above; and

FIG. 11 shows a layout of the contact socket according to FIGS. 8 to 10.

### DETAILED DESCRIPTION OF THE PREFERRED EMBODIMENT

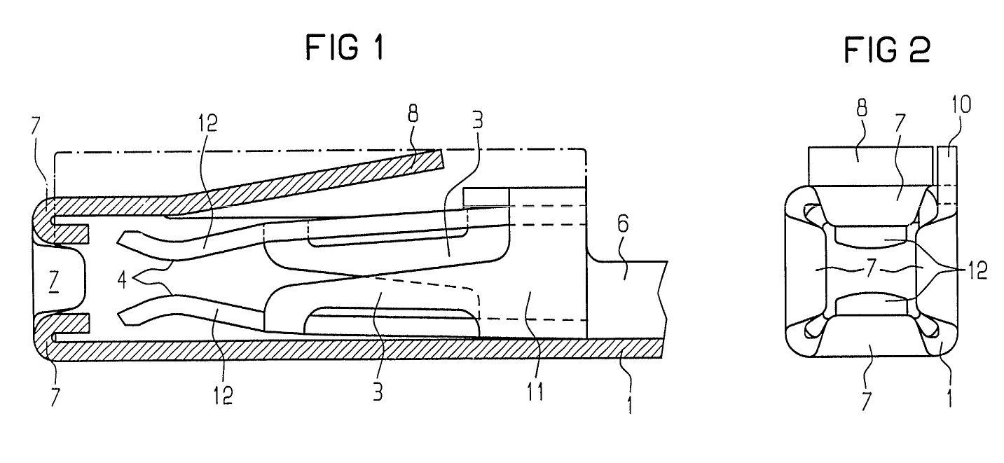

FIGS. 1 and 3 of a first preferred embodiment show a contact socket according to the invention in a lateral cross-sectional view. According to FIG. 1, a base spring 1 is shown having two spring legs 12, which essentially face each other with their contact sections 4 on the inside of the base spring 1. According to this first embodiment, an external latching tongue 8 is formed on the base spring 1 (shown on top in FIGS. 1 and 2). The spring legs 12 lie inside base spring 1.

According to the view of FIG. 1, a facing second (lower) spring leg 12 is foreseen on the base spring 1 opposite the first (upper) spring leg 12 such that the contact sections 4 of spring legs 12 face each other in the plug-in direction, in the left half of base spring 1. It can furthermore be clearly seen from FIGS. 1 and 2 that spring legs 12 are accommodated inside the base spring 1. The latching tongue 8 protrudes upwards at an acute angle of approximately 5° to 10° beyond the base spring 1. Both spring legs 12 form resilient contacting metal pieces which conduct the current directly and therefore conduct it more efficiently.

FIG. 3 shows the layout of base spring 1. This view is not to scale. The layout of base spring 1 with integral spring legs 12 has a compact form with reduced loss of sheet metal during stamping. Base spring 1 further comprises a projection 10 which is bent from the base spring 1 approximately at a right angle, as shown in FIG. 2, in order to form a polarisation of the contact socket. The contours of the layout of base springs 1 are preferably stamped out of flat metal sheets, or possibly also cut by means of a laser, as shown in FIG. 3. After the stamping operation the individual base springs 1 are separated and are each bent and/or pressed until finally the state as shown in FIGS. 1 and 2 is obtained. The base spring 1 can preferably be soldered by means of a laser, such that at least one solder pad is placed on one location in the tool from above in order to fix the base spring 1.

The construction of the present contact socket according to the invention, in particular through the cooperation of both spring legs 12, allows creation of the relatively high resilient force whereby an improved spring action of the spring components can be achieved. In the shown contact socket according to the first embodiment, in order to further increase the spring action, both spring legs 12 are each supported by a support member 3. This support member 3 is formed by means of a free punch 5 (see FIG. 2) and is connected to base spring 1 by means of a base 11.

Each support member has an essentially U-shaped configuration whereby a base section of the U-shape creates a connection between the base 11 and the other end of support member 3. The chamfered connection between support member 3 and the corresponding spring leg 12 is formed in the vicinity of contacting section 4 such that each spring leg 12 with the surrounding base spring 1 forms a gap which opens in the direction of the insertion opening of the contact socket. In order to increase the resilient force of both spring legs 12, they are each supported by support member 3.

Finally, several tabs 7 are formed on both sides of an insertion opening (of base spring 1) for a contact pin (not shown), which tabs show outwardly rounded contours and facilitate the insertion of the contact pin. The tabs 7 also serve, as can be seen from FIG. 2, to prevent an insertion behind spring leg 12.

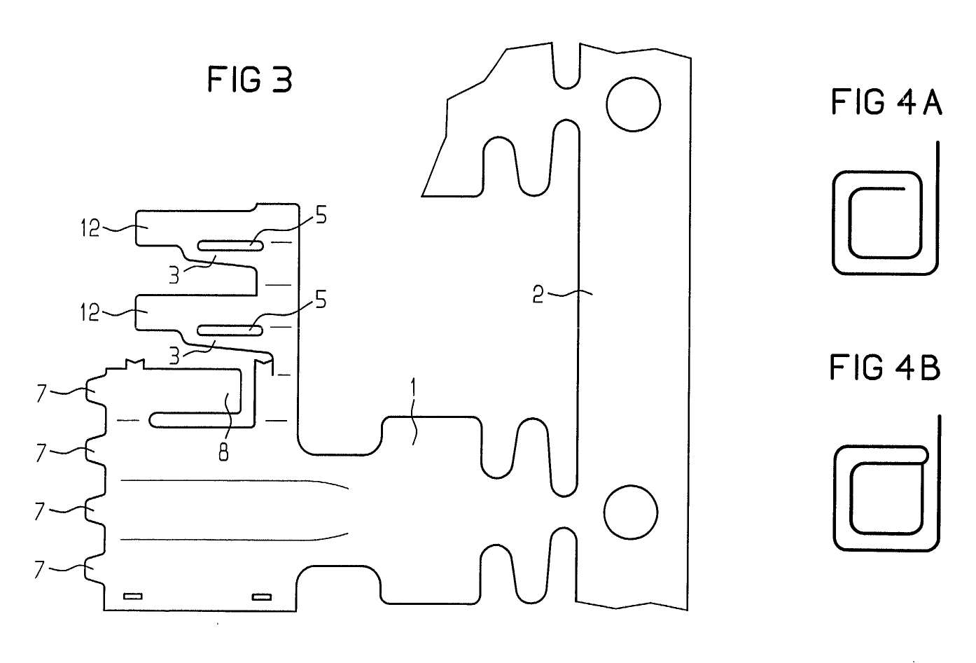

FIG. 4 schematically shows two possible folds a) and b) of the contact socket according to the invention. Alternative (a) shows a helically wound or folded contact socket, while alternative (b), with a blank that is rotated by 180° for the contacts, shows a fold which follows the contours of a square, whereby each side is covered twice.

FIGS. 5 to 7 show a contact socket according to the invention, in accordance with a second preferred embodiment, whereby here in a lateral cross-sectional view according to FIG. 5 a base spring 1 is also shown, on which two spring legs 12 are foreseen, which essentially face each other with their contact sections 4 on the inside of the base spring 1.

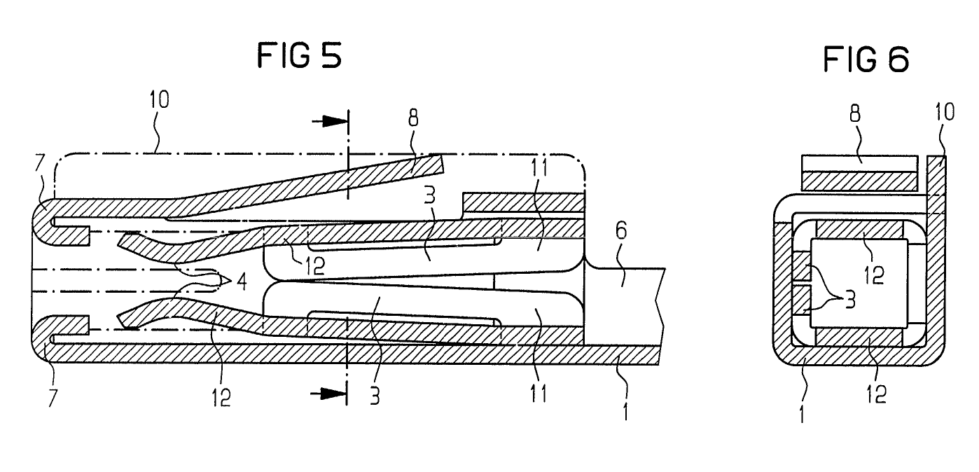

According to this second embodiment, an external latching tongue 8 is formed on the base spring 1 (shown on top in FIGS. 5 and 6). The spring legs 12 lie inside base spring 1.

According to the view of FIG. 5, a facing second (lower) spring leg 12 is foreseen on the base spring 1 opposite the first (upper) spring leg 12 such that the contact sections 4 of spring legs 12 face each other in the plug-in direction, in the left half of base spring 1. It can also be seen from FIGS. 5 and 6 that spring legs 12 are completely accommodated inside the base spring 1. The latching tongue 8 protrudes upwards at an acute angle of approximately 10° beyond the base spring 1. Both spring legs 12 form resilient contacting metal pieces which conduct the current directly and therefore conduct it more efficiently.

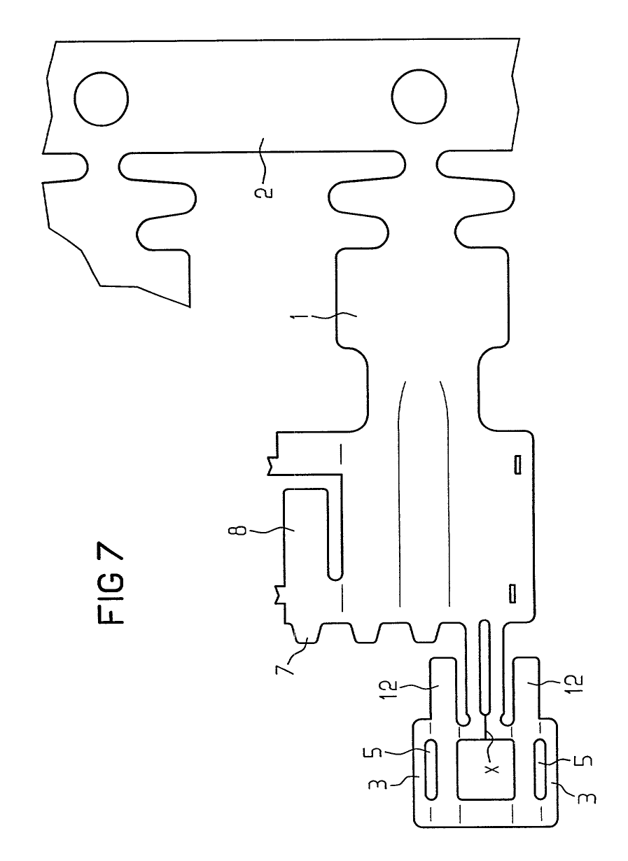

FIG. 7 shows the layout of base spring 1. This view is not to scale. The layout of base spring 1 with integral spring legs 12 has an extremely compact form with reduced loss of sheet metal during stamping. The connection of spring legs 12 and the corresponding support member 3 (which will be described later) takes place in this embodiment on the left frontal side of base spring 1. On the base spring 1 a projection 10 is additionally foreseen which is bent approximately at a right angle from base spring 1, as shown in FIG. 2, to form a polarisation of the contact socket.

The contours of the layout of base springs 1 are preferably stamped out of flat metal sheets or, possibly, also cut by means of a laser, as shown in FIG. 7. A separation cut takes place at position X, in order to form the two spring legs 12 such that they can move away from each other, namely for the case when the contact pin is later inserted. After the stamping operation, the individual base springs 1 are separated and are each bent and/or pressed until finally the state as shown in FIG. 5 and 6 is obtained. The base spring 1 can preferably be soldered by means of a laser, such that at least one solder pad is placed on one location in the tool from above in order to fix the base spring 1.

The construction of the present contact socket according to the invention, in particular through the cooperation of both spring legs 12, allows creation of the relatively high resilient force whereby an improved spring action of the spring components can be achieved.

In the shown contact socket according to the second embodiment, in order to further increase the spring action, both spring legs 12 are each also supported by a support member 3. This support member 3 is formed by means of a free punch 5 (see FIG. 7) and is connected to base spring 1.

Each support member has an essentially U-shaped configuration whereby a longitudinal base section of the U-shape creates a connection between base 11 and the other end of support member 3. The chamfered connection between support member 3 and the corresponding spring leg 12 is formed in the vicinity of contacting section 4 such that each spring leg 12 with surrounding base spring 1 forms a gap which opens in the direction of the insertion opening of the contact socket. In order to increase the resilient force of both spring legs 12, they are each supported by support member 3.

Finally, several tabs 7 are formed on both sides of an insertion opening (of base spring 1) for a contact pin (not shown), which tabs show outwardly rounded contours and facilitate the insertion of the contact pin. The tabs 7 also serve, as can be seen from FIG. 5, to prevent an insertion behind spring leg 12.

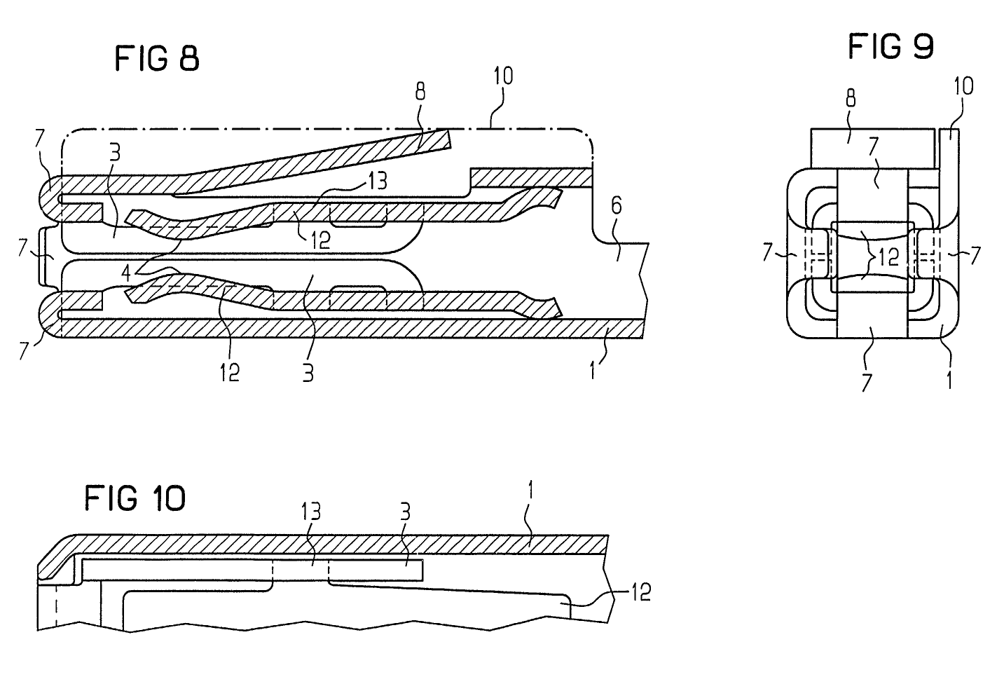

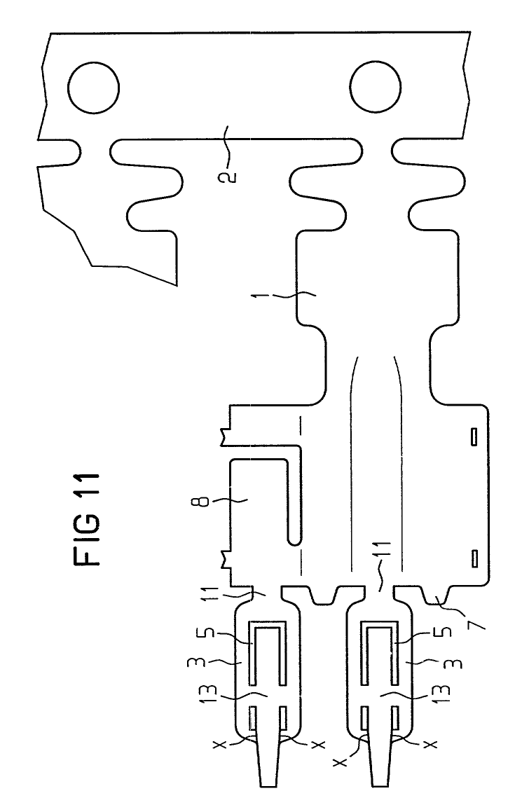

FIGS. 8 and 11 show a contact socket according to the invention, in accordance with a third preferred embodiment, whereby here in a lateral cross-sectional view according to FIG. 8 a base spring 1 is also shown, on which two spring legs 12 are foreseen, which essentially face each other with their contact sections 4 on the inside of the base spring.

According to this second embodiment an external latching tongue 8 is formed on the base spring 1 (shown on top in FIGS. 8 and 9). The spring legs 12 lie inside base spring 1.

According to the view of FIG. 8, a facing second (lower) spring leg 12 is foreseen on the base spring 1 opposite the first (upper) spring leg 12 such that the contact sections 4 of spring legs 12 face each other in the plug-in direction, in the left half of base spring 1. It can be seen from FIGS. 8 and 9 that spring legs 12 are completely accommodated inside the base spring 1. The latching tongue 8 protrudes upwards at an acute angle of approximately 10° beyond the base spring 1. Both spring legs 12 form resilient contacting metal pieces which conduct the current directly and therefore conduct it more efficiently.

FIG. 11 shows the layout of base spring 1. This view is not to scale. The layout of base spring 1 with integral spring legs 12 has an extremely compact form with reduced loss of sheet metal during stamping. The connection of the spring legs 12 and the corresponding support member 3 (which will be described later) takes place in this embodiment on the left frontal side of base spring 1. Base spring 1 further comprises a projection 10 which is bent from the base spring 1 approximately at a right angle, as shown in FIG. 9, in order to form a polarisation of the contact socket.

The contours of the layout of base springs 1 are preferably stamped out of flat metal sheets or, possibly, also cut by means of a laser, as shown in FIG. 11. A separation cut takes place at the four positions X, in order to form the two spring legs 12 such that they can move away from each other, namely for the case when the contact pin is later inserted. After the stamping operation the individual base springs 1 are separated and are each bent and/or pressed until finally the state as shown in FIGS. 8 and 9 is obtained.

The base spring 1 can preferably be soldered by means of a laser, such that at least one solder pad is placed on one location in the tool from above in order to fix the base spring 1. The construction of the present contact socket according to the invention, in particular through the cooperation of both spring legs 12, allows creation of the relatively high resilient force whereby an improved spring action of the spring components can be achieved.

In the shown contact socket according to the second embodiment, in order to further increase the spring action, both spring legs 12 are also supported each on both sides by two support members 3. The support members 3 are formed by means of a free punch 5 (see FIG. 11) and are connected to the base spring 1.

Each support member 3 has an essentially U-shaped configuration whereby a longitudinal base section of the U-shape creates a connection between base 11 and the other end of support member 3. The chamfered ends of each support member 3 are formed without a direct connection to the spring leg 12. However, each spring leg 12 is mounted in a seesaw manner in the middle of support member 3 and connected to support member 3. In order to increase the resilient force of both spring legs 12, they are supported in a seesaw manner at a fulcrum 13 by support member 3. As can be seen from the partial sectional top view shown in FIG. 10, the fulcrum 13 is formed on the spring leg 12 approximately in the middle between support member 3 and spring leg 12.

Finally, several tabs 7 are formed on both sides of an insertion opening (of base spring 1) for a contact pin (not shown), which tabs show outwardly rounded contours and facilitate the insertion of the contact pin. The tabs 7 also serve, as can be seen from FIG. 8, to prevent an insertion behind the lower spring leg 12.

In summary, the contact socket according to the invention, which is of a single-part construction, comprises a base spring 1 and two spring legs 2 which are integrally formed on the base sleeve 1. Both spring legs 12 comprise contacting sections 4, essentially facing each other. As a result of the single-piece construction the manufacturing process of this contact socket can be optimized. Furthermore, each spring legs 12 is supported by an additional support member 3 thereby increasing the resilient force of spring leg 12. For further characteristics and advantages of the present invention, specific reference is hereby made to the appended claims and drawings.

I/we claim:

1. A contact socket of single-part construction, comprises a box-like base spring with two internal spring legs having contacting sections which face each other inside the base spring, characterized in that each spring leg is supported by at least one support member.

2. The contact socket according to claim 1, characterized in that the base spring comprises a latching tongue which outwardly protrudes from base spring.

3. The contact socket according to claim 2, characterized in that the support member is integrally formed on the base spring.

4. The contact socket according to claim 3, characterized in that the base spring is made of a copper alloy.

5. The contact socket according to claim 4, characterized in that each support member supports the corresponding spring leg and thereby increases the resilient force of spring leg.

6. The contact socket according to claim 5, characterized in that the support of spring leg by the support member takes place in the lateral or frontal region of spring member.

7. The contact socket according to claim 7, characterized in that the base spring is fixed in the final state by at least one soldering point.

8. The contact socket according to claim 7, characterized in that the base spring is manufactured from a flat metal sheet by stamping, bending, cutting and/or pressing.

9. The contact socket according to claim 8, characterized in that a polarisation in the form of a projection is formed on the base spring.

10. The contact socket according to claim 9, characterized in that the support of spring leg by the support member is such that spring leg can pivot in a limited manner around a fulcrum in the manner of a seesaw.

11. The contact socket according to claim 10, characterized in that at least one tab which serves as insertion help for a contact pin is provided on the frontal side of base spring.
